(19) United States
(12) Patent Application Publication
(10) Pub. No.: US 2017/0323262 A1
(43) Pub. Date: Nov. 9, 2017

(54) COURIER MANAGEMENT SYSTEMS

(71) Applicant: Ryan William Hillis, Burlington (CA)

(72) Inventor: Ryan William Hillis, Burlington (CA)

(21) Appl. No.: 15/148,070

(22) Filed: May 6, 2016

(51) Int. Cl. G06Q 10/08

(52) U.S. Cl. CPC G06Q 10/0834

(57) ABSTRACT

A courier management system for parcel pickup and delivery scheduling using a courier management web application run through a smart electronic device for the delivery of merchandise. Persons and businesses can request a driver to pick-up/deliver merchandise without resorting to traditional shipping options. A package is picked up by a driver and delivered the same day. Drivers have the option of choosing routes closest to the pick-up and delivery locations, and all information is processed through the courier management web application including pick-up and delivery locations, driver licensing information, and online payment for services.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of courier services and parcel handling and more specifically relates to parcel pickup and delivery scheduling.

### 2. DESCRIPTION OF RELATED ART

Many people ship parcels either for personal or business reasons. Some of these people travel to their local shipping facility while others have people pick up their parcel to be shipped later that day. Timely delivery is often a factor as well as pricing; if a parcel is late or too expensive to ship it may not get to the destination. One such alternative to having a parcel pickup service is a parcel courier, a person which may be used as a parcel courier to take a parcel to a destination of their choosing for a predetermined price.

Parcel couriers are often preferred in large cities, due to the travel time and cost of using a personal vehicle to locate a post office or parcel shipping center. However, determining and locating a courier in highly populated areas is a difficult task. Commonly a person would have to call a dispatch center to see if a courier is in the area and available for hire. Once a courier becomes available you must then discuss a cost for service to pick up a parcel, this is a very time consuming processes. A suitable solution is desired.

Several attempts have been made to solve the above-mentioned problems such as those found in U.S. Pub. Nos. 2016/0019496 to Marc Gorlin; 2004/0219933 to Jonathan David Faith; 2009/0012802 to John F. Wynne; 2015/0039362 to Mashhur Zarif Haque; 2004/0030572 to Helen Campbell et al.; 2013/0080347 to Boris Paul et al.; 2008/0210749 to Ole-Petter Skaaksrud et al.; U.S. Pat. No. 8,473,326 to Charles M. Griffith et al.; and U.S. Pat. No. 7,248,160 to Anthony Mangan et al. This art is representative of parcel handling. However, none of the above inventions and patents, taken either singly or in combination, is seen to describe the invention as claimed.

Preferably, a courier management system should provide parcel pickup and delivery scheduling using a courier management web application run through a smart electronic device for the delivery of merchandise and, yet would operate reliably and be manufactured at a modest expense. Thus, a need exists for a reliable courier management system to avoid the above-mentioned problems.

### BRIEF SUMMARY OF THE INVENTION

In view of the foregoing disadvantages inherent in the known parcel handling art, the present invention provides a novel courier management system. The general purpose of the present invention, which will be described subsequently in greater detail is to provide parcel pickup and delivery scheduling using a courier management web application run through a smart electronic device for the delivery of merchandise.

A courier management system is disclosed herein, in a preferred embodiment, comprising: a courier management web application comprising a hiring system comprising, a driver proximity locator, a weight calculator, a delivery time calculator, a final destination estimator, and a tracking system comprising a carrier GPS device. Courier management system comprises the courier management web application, and the courier management web application comprises in functional combination the hiring system, the weight calculator, the delivery time calculator, the final destination estimator, and the tracking system. The hiring system comprises the driver proximity locator which is directed through the courier management web application on a smart electronic device, and denotes proposed routes to a driver. The courier management web application is capable of displaying photos on the smart electronic device, and the courier management web application stores information on the drivers by scanning a license of the driver with the smart electronic device camera.

The courier management web application requests replacement of the driver in event of a vehicle breakdown. The courier management web application stores pick-up and delivery addresses for merchandise as well as the weight calculator, the delivery time calculator, and the final destination estimator, which then provides package delivery service information through the courier management web application on the smart electronic device. The courier management web application is capable of sorting requests by distance, and distance is calculated in minutes. The courier management web application is capable of sorting the requests by location, price, size, and timing. The courier management web application submits information of a person placing the request along with billing details of the person, and processes payments through the courier management web application for payment of the requests upon delivery. The courier management web application creates unique codes to verify the delivery has been completed. The hiring system and the driver proximity locator discover a driver and allows a driver to transport at least one package between desired locations. The courier management web application suggests routes for the driver to travel while delivering the merchandise. The courier management web application furnishes tangible output of package delivery to an end-user in an efficient and cost-effective manner.

The courier management system kit is also disclosed herein, including: a mobile application software; and a set of user instructions.

A method of using a courier management system is also disclosed herein comprising the steps of: downloading courier management web application; logging into courier management web application; acquiring a driver through courier management web application; scheduling a pick-up through courier management web application; paying for service through courier management web application; tracking progress of delivery through courier management web application; and confirming delivery of merchandise through courier management web application. The method may further comprise the steps of: printing a receipt of completed transaction; and providing feedback on driver after completed transaction.

The present invention holds significant improvements and serves as a courier management system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, courier management system, constructed and operative according to the teachings of the present invention.

FIG. 1 shows a perspective view illustrating a courier management system during an ‘in-use’ condition showing a requested driver in process of delivering a package through the courier management web application on an electronic device, where the driver's cell phone is tracked through GPS according to an embodiment of the present invention.

FIG. 2 is a perspective view illustrating the courier management system comprising a list of options for the courier management web application as shown using by using a smart electronic device according to an embodiment of the present invention of FIG. 1.

FIG. 3 is a perspective view illustrating the courier management system showing a user receiving an acknowledgement for a scheduled pick-up according to an embodiment of the present invention of FIGS. 1-2.

FIG. 4 is a perspective view illustrating the courier management system showing a driver delivering a requested package with a smart electronic device indicating package delivery completion according to an embodiment of the present invention of FIGS. 1-3.

FIG. 5 is a flowchart illustrating a method of use for the courier management system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to parcel handling and more particularly to a courier management system as used to improve efficiency in parcel pickup and delivery scheduling.

Generally speaking, the present invention is an application for courier sharing services. Products are delivered from one location to another by hiring a driver nearby through the application. Existing smart electronic device technology pinpoints driver locations, and connects a driver with a business close to the driver for pick-up and delivery of products. Once a driver is hired, they are able to log onto the app and begin pick-up and delivery service. Customers who are in need of this service log on and are connected with drivers who are logged on, and close by who can pick up their items and deliver them to their destination. Based on their delivery needs (such as weight, delivery time and location), prices are calculated accordingly, charged within the app (via credit card), payments are then received and shared between company and driver. The application will essentially be a courier sharing service that lowers costs for companies and consumers.

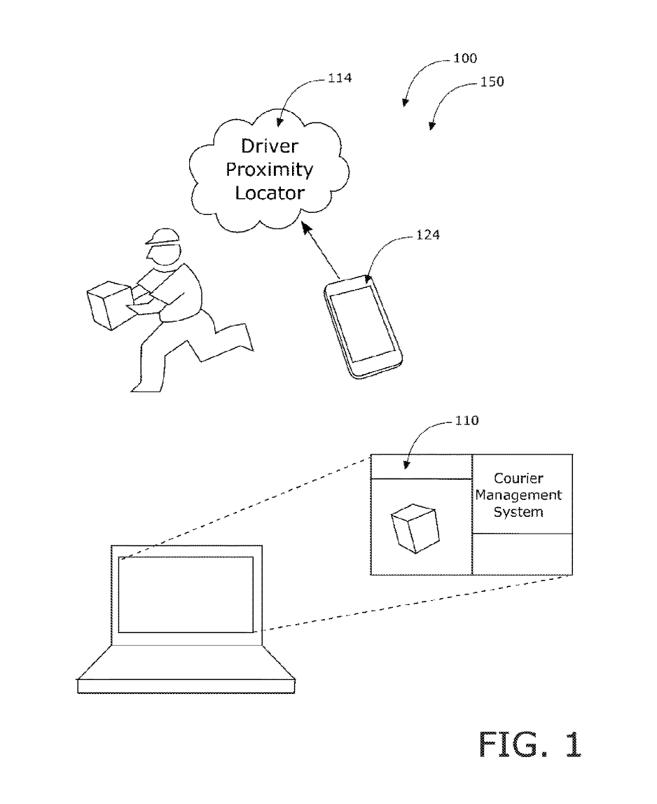

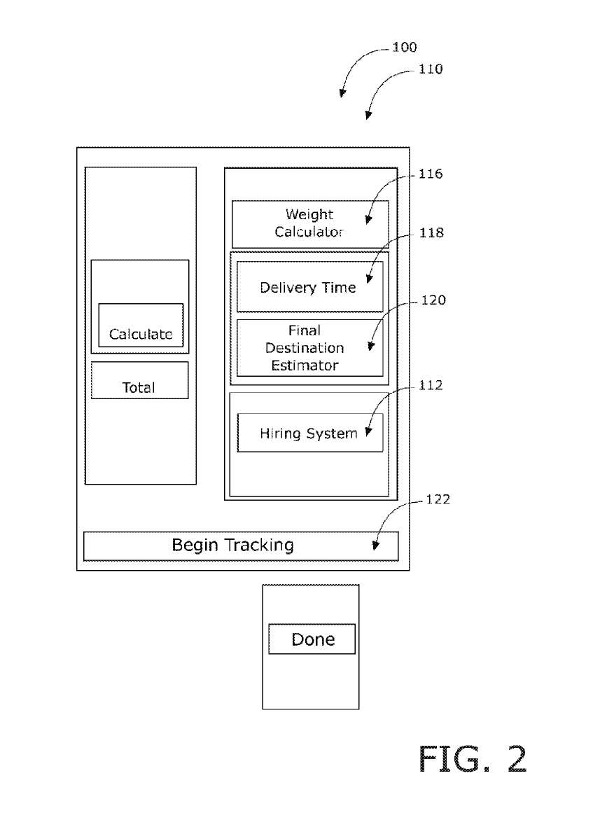

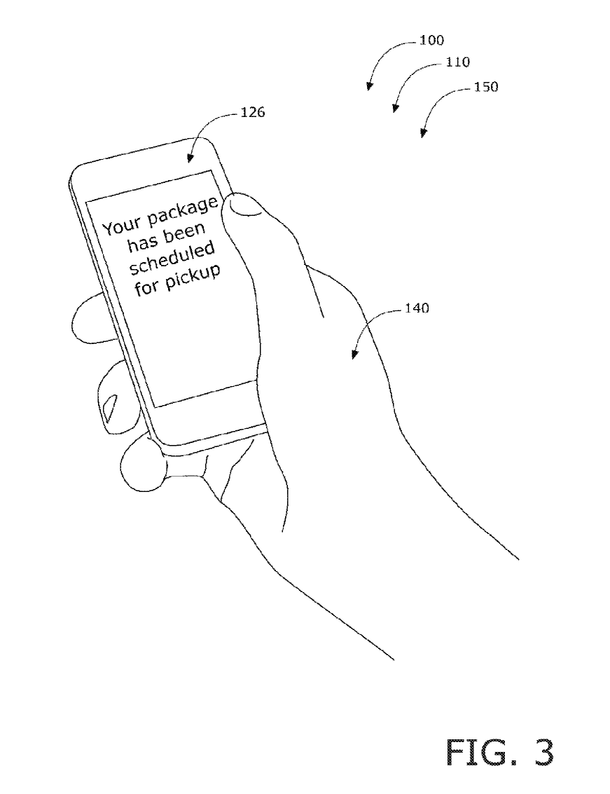

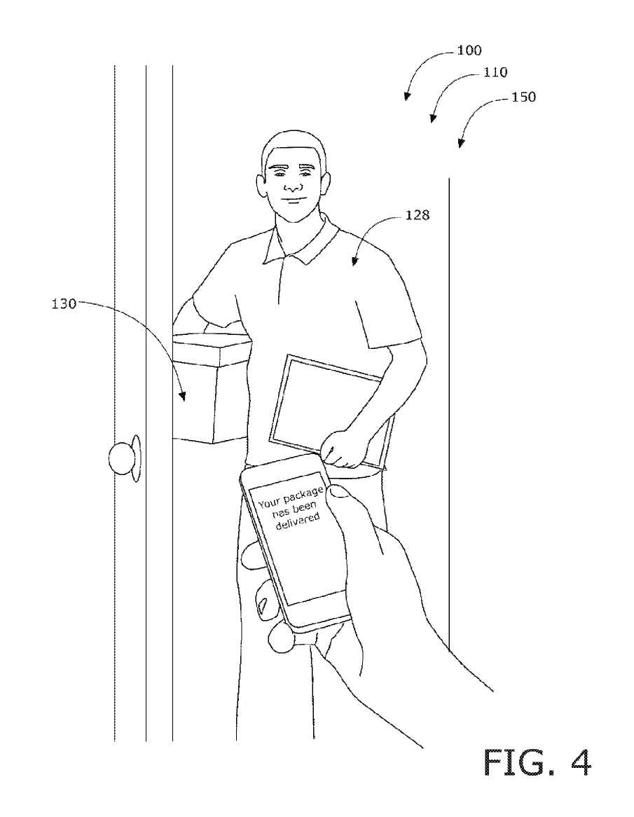

Referring to the drawings by numerals of reference there is shown in FIGS. 1-4, courier management system 100 comprising courier management web application 110 comprising hiring system 112 comprising driver proximity locator 114, weight calculator 116, delivery time calculator 118, final destination estimator 120, and tracking system 122 comprising carrier GPS device 124.

Courier management web application 110 comprises in functional combination hiring system 112, weight calculator 116, delivery time calculator 118, final destination estimator 120, and tracking system 122. Hiring system 112 comprises driver proximity locator 114 which is directed through courier management web application 110 on smart electronic device 126, wherein weight calculator 116, delivery time calculator 118, and final destination estimator 120 provide package delivery service information through courier management web application 110 on smart electronic device 126. Hiring system 112 and driver proximity locator 114 discover driver 128 to transport at least one package 130 between desired locations, and wherein courier management web application 110 furnishes tangible output of package delivery to an end-user in an efficient and cost-effective manner.

Courier management web application 110 submits information from a person placing a request along with billing details of the person. Courier management web application 110 denotes proposed routes to driver 128. Courier management web application 110 requests replacement of driver 128 in event of a vehicle breakdown. Courier management web application 110 stores pick-up and delivery address for merchandise. Courier management web application 110 sorts requests by distance, and distance is calculated in minutes. Courier management web application 110 also sorts requests by location, price, size, and timing. Courier management web application 110 is capable of displaying photos on smart electronic device 126. Courier management web application 110 stores information on driver(s) 128 by scanning a license of driver 128 with smart electronic device 126 camera. Courier management web application 110 processes payments through courier management web application 110 for payment of requests upon delivery. Courier management web application 110 creates unique codes to verify delivery has been completed. Courier management web application 110 suggests routes for driver 128 to travel while delivering merchandise.

Courier management system 100 may be sold as kit 440 comprising the following parts: at least one mobile application software; and at least one set of user instructions. The kit has instructions such that functional relationships are detailed in relation to the structure of the invention (such that the invention can be used, maintained, or the like in a preferred manner). Courier management system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different delivery means and combinations, parts may be sold separately, etc., may be sufficient.

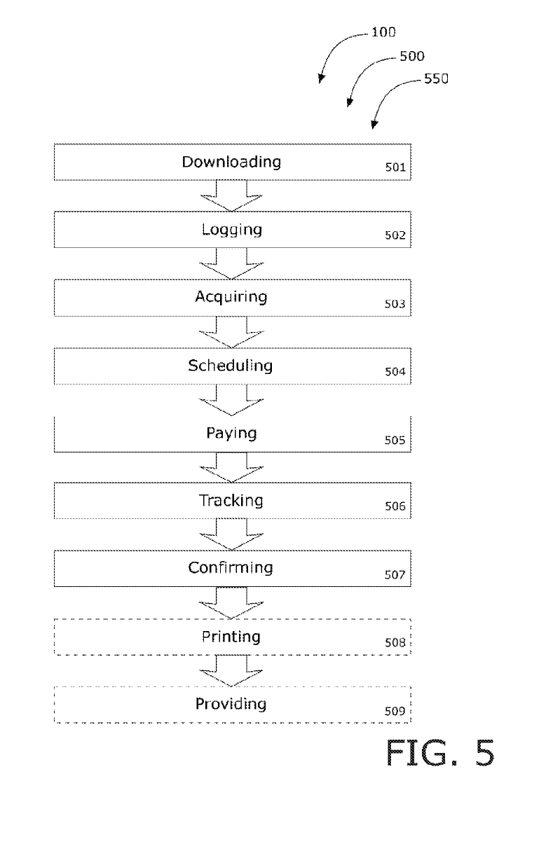

Referring now to FIG. 5 showing flowchart 550 illustrating method of use 500 for courier management system 100 according to an embodiment of the present invention of FIGS. 1-4. As shown, method of use 500 may comprise the steps of: step one 501, downloading courier management web application 110; step two 502, logging in to courier management web application 110; step three 503, acquiring a driver 128 through courier management web application 110; step four 504, scheduling a pick-up through courier management web application 110; step five 505, paying for service through courier management web application 110; step six 506, tracking progress of delivery through courier management web application 110; step seven 507, confirming delivery of merchandise through courier management web application 110; step eight 508, printing a receipt of completed transaction; and step nine 509, providing feedback on driver 128 after completed transaction.

It should be noted that step 508 and 509 are optional steps and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A courier management system comprising:
a courier management web application comprising;
a hiring system comprising;
a driver proximity locator;
a weight calculator;
a delivery time calculator;
a final destination estimator; and
a tracking system comprising;
a carrier GPS device;
wherein said courier management system comprises said courier management web application;
wherein said courier management web application comprises in functional combination said hiring system, said weight calculator, said delivery time calculator, said final destination estimator, and said tracking system;
wherein said hiring system comprises said driver proximity locator which is directed through said courier management web application on a smart electronic device;
wherein said weight calculator, said delivery time calculator, and said final destination estimator provide package delivery service information through said courier management web application on said smart electronic device;
wherein said hiring system and said driver proximity locator discover a driver to transport at least one package between desired locations; and
wherein said courier management web application furnishes tangible output of package delivery to an end-user in an efficient and cost-effective manner.

2. The courier management system of claim 1 wherein said courier management web application submits a person placing a request along with billing details of said person.

3. The courier management system of claim 1 wherein said courier management web application denotes proposed routes to said driver.

4. The courier management system of claim 3 wherein said courier management web application requests replacement of said driver in event of a vehicle breakdown.

5. The courier management system of claim 1 wherein said courier management web application stores pick-up and delivery address for merchandise.

6. The courier management system of claim 2 wherein said courier management web application sorts said requests by distance.

7. The courier management system of claim 6 wherein said distance is calculated in minutes.

8. The courier management system of claim 6 wherein said courier management web application sorts said requests by location.

9. The courier management system of claim 6 wherein said courier management web application sorts said requests by price.

10. The courier management system of claim 6 wherein said courier management web application sorts said requests by size.

11. The courier management system of claim 6 wherein said courier management web application sorts said requests by timing.

12. The courier management system of claim 1 wherein said courier management web application is capable of displaying photos on said smart electronic device.

13. The courier management system of claim 12 wherein said courier management web application stores information on said driver(s) by scanning a license of said driver with said smart electronic device camera.

14. The courier management system of claim 1 wherein said courier management web application processes payments through said courier management web application for payment of requests upon delivery.

15. The courier management system of claim 14 wherein said courier management web application creates unique codes to verify said delivery has been completed.

16. The courier management system of claim 5 wherein said courier management web application suggests routes for said driver to travel while delivering said merchandise.

17. A courier management system comprising:
a courier management web application comprising;
a hiring system comprising;
a driver proximity locator;
a weight calculator;
a delivery time calculator;
a final destination estimator; and
a tracking system comprising;
a carrier GPS device;
wherein said courier management system comprises said courier management web application;
wherein said courier management web application comprises in functional combination said hiring system, said weight calculator, said delivery time calculator, said final destination estimator, and said tracking system;
wherein said hiring system comprises said driver proximity locator which is directed through said courier management web application on a smart electronic device;
wherein said courier management web application denotes proposed routes to a driver;
wherein said courier management web application is capable of displaying photos on said smart electronic device;
wherein said courier management web application stores information on said drivers by scanning a license of said driver with said smart electronic device camera;
wherein said courier management web application requests replacement of said driver in event of a vehicle breakdown;
wherein said courier management web application stores pick-up and delivery address for merchandise;
wherein said weight calculator, said delivery time calculator, and said final destination estimator provide package delivery service information through said courier management web application on said smart electronic device;
wherein said courier management web application is capable of sorting said requests by distance;
wherein said distance is calculated in minutes;
wherein said courier management web application is capable of sorting said requests by location;
wherein said courier management web application is capable of sorting said requests by price;
wherein said courier management web application is capable of sorting said requests by size;
wherein said courier management web application is capable of sorting said requests by timing;
wherein said courier management web application submits a person placing said request along with billing details of said person;
wherein said courier management web application processes payments through said courier management web application for payment of said requests upon delivery;
wherein said courier management web application creates unique codes to verify said delivery has been completed;
wherein said hiring system and said driver proximity locator discover allows a driver to transport at least one package between desired locations;
wherein said courier management web application suggests routes for said driver to travel while delivering said merchandise; and
wherein said courier management web application furnishes tangible output of package delivery to an end-user in an efficient and cost-effective manner.

18. The courier management system of claim 17 further comprising a kit including:
said mobile application software; and
a set of user instructions.

19. A method of using a courier management system comprising the steps of:
downloading courier management web application;
logging in to courier management web application;
acquiring a driver through courier management web application;
scheduling a pick-up through courier management web application;
paying for service through courier management web application;
tracking progress of delivery through courier management web application; and
confirming delivery of merchandise through courier management web application.

20. The method of claim 19 further comprising the steps of:
printing a receipt of completed transaction; and
providing feedback on driver after completed transaction.
